(19) United States
(12) Patent Application Publication
(10) Pub. No.: US 2011/0131905 A1
(43) Pub. Date: Jun. 9, 2011

(54) CEMENTITIOUS DECK OR ROOF PANELS AND MODULAR BUILDING CONSTRUCTION

(76) Inventors: Paul Aumuller, Guelph (CA); Ed Newton, Guelph, CA (US); Thomas Koester, Guelph (CA)

(21) Appl. No.: 12/870,240

(22) Filed: Aug. 27, 2010

Related U.S. Application Data
(60) Provisional application No. 61/267,257, filed on Dec. 7, 2009.

(30) Foreign Application Priority Data
Feb. 27, 2010 (CA) 2695038

(51) Int. Cl. E04C 5/08; E04C 2/06; E04C 2/08; B28B 15/00

(52) U.S. Cl. 52/223.6; 52/630; 52/782.1; 425/88

(57) ABSTRACT

An improved cementitious panel of the type which, in use, is supported, with its upper surface in biaxial compression, by steel beams and forms part of a deck or roof in a modular structure, wherein the improvement comprises a single layer of reinforcement in the panel.

### CROSS-REFERENCE TO RELATED APPLICATIONS

This application is related to, and claims benefit of, U.S. Provisional Application Ser. No. 61/267,257, filed Dec. 7, 2009, Canadian Patent Application Serial Number 2,695,038, filed Feb. 27, 2010, and Canadian Patent Application Serial Number ______, filed Aug. 25, 2010, the disclosures of which are incorporated herein by reference in their entireties.

### FIELD OF THE INVENTION

The present invention relates to modular buildings, such as parking structures.

### BACKGROUND

Modular parking structures are well known in the art. One structure used in Europe is the system sold under the trade-mark GOBACAR by GOLDBECK GmbH. This structure comprises pre-cast cementitious (steel-reinforced concrete) parking deck panels which are set onto cambered beams which in turn are fastened to and supported by vertical perimeter steel columns. The structure offers a visually attractive free-span design. As such, the usefulness of the structure is not limited to use in parking structures and it is known to be employed for other multi-level structures.

The process of assembling the GOBACAR structure generally comprises the following steps:
assembling the beams and columns into a support structure;
installing temporary horizontal beam support;
placing the panels;
grouting the gaps; and
removing the temporary horizontal beam support.

### Concrete Deck Panel

A concrete panel of the prior art will now be described with general reference to FIGS. 1-3 of the drawings.

The concrete panel 100 is generally rectangular in shape and planar. On two opposite sides 102,104 of the panel there are provided a plurality of recesses 106. In this panel, these sides are 2.5 metres apart. On the other two sides 108,110 there are defined grooves 112. In this panel, these sides are about 9.0 metres apart.

A plurality of hook bars 114 in the form of 13 mm diameter u-shaped rebar elements are cast in the concrete such that the rebar lies substantially coplanar with the panel, the open ends of the hook bars are embedded in the concrete and the looped ends protrude into the recesses 106.

Two rebar reinforcement lattices 116 are provided. The lattices 116 are disposed in stacked, spaced relation, centered within the body of the panel 100 and dimensioned similarly to but slightly smaller than the panel such that, when positioned, there is clearance between the rebar lattices 116 and the outer edges of the concrete. The rebar in the lattices 116 is tied together with steel wire.

The thickness of the panel is 103 mm and is denoted by dimension A1 in FIG. 3. The minimum depth of the u-shaped rebar elements 114 and the rebar mat 116 from the upper surface of the panel, i.e. the amount of concrete coverage, ranges between 42 mm and 45 mm and is denoted by dimension B1 in FIG. 3.

### The Support Structure

A support structure is shown schematically in FIG. 4 and will be seen to include a group of horizontal cambered beams 118. The beams 118 are substantially parallel, coplanar and laterally spaced from one another.

A plurality of substantially vertical columns 120 are regularly-spaced, disposed in two rows and connected to beams 118 such that each beam 118 is supported at its ends by a pair of the columns 120. The beams 118 and columns 120 are joined together by fasteners (not shown) and all are usually galvanized. The use of fasteners as compared to welds not only maintains the galvanization, therefore protecting the steel from the elements, but allows for a modular design that can be relatively quickly and easily assembled (or disassembled at end-of-life). The camber in the beams 118 is such that each beam 118, when installed, is slightly higher at its midpoint than at its ends. Each beam 118 has on its upper convex surface a plurality of Nelson studs 122. The outermost beams 118 have the studs 122 disposed in a single row; the inner beams 118 have paired studs 122.

### Employing Horizontal Beam Support

The temporary horizontal beam support involves the placement of a jack 124 at the end of each beam 118, as shown in FIG. 5.

### Panel Placement

With the beams 118 temporarily reinforced by the jacks, the roof/deck panels 100 are set on the beams 118, such that each panel 100 is supported at its sides 102,104 by an adjacent pair of the horizontal beams 118 and such that each adjacent pair of horizontal beams 118 supports a plurality of deck panels 100, which panels 100 are arranged in end-to-end relation, thereby to define transverse gaps 126 between longitudinally-adjacent deck panels and longitudinal gaps 128 between laterally-adjacent deck panels, all as shown in FIG. 6.

In the course of assembly, the looped-ends of the u-shaped rebar hooks 114 are placed over the Nelson studs 122 which protrude from the beams 118, thereby to provide a mechanical connection between the panels 100 and beams 118 and to provide a rough location mechanism.

This is illustrated more clearly in FIG. 7, which shows a side view of a beam 118, a plurality of Nelson studs 122 protruding from the beam 118, the sides of a pair of longitudinally-adjacent panels 100 and the hook bars 114 protruding therefrom engaged with the Nelson studs 122.

At the ends of the beam 118, closed hooks 130 are laid upon adjacent hook bars 114, to mechanically connect laterally-adjacent Nelson studs 122, as shown in FIG. 8.

To ensure proper positioning of the deck panels 100 on the beams 118, a locating pin may be precisely placed on the beam, and a socket, for receiving the pin in tight-fitting, locating relation, may be cast on the panel (none shown). The pin/socket arrangement also provides a mechanical connection between the panels and beams, which is of advantage in the assembly process in that it braces the structure together.

### Filling the Gaps and Releasing Horizontal Beam Support

Once the panels 100 are properly positioned, the transverse gaps 126 and longitudinal gaps 128 are filled with a grout. To temporarily hold the grout in place during solidification, foam gaskets (not shown) are fitted on the beams 118, and at the base of the transverse gaps 126. Once the grout has hardened, the horizontal beam supporting jacks 124 are removed. Removal of the jack supports 124 allows the weight of the concrete panels 100 to reduce the camber of the horizontal beams 118 through elastic deformation. This deformation of the underlying beams 118 causes the upper surface of the concrete panels 100 to be put into compression, in a direction parallel to the beams 118. The upper surfaces of the deck panels 100 are also in compression in a transverse direction, as a result of the side support thereof (by the adjacent beams 118).

FIGS. 9-11 show the structure after the grout has hardened and the jacks have been removed.

These aforementioned biaxial compressive stresses tend to avoid crack propagation in the concrete upper surface.

An impermeable waterproofing topping 132 is advantageously applied at least over the grout, as the upper surface of the grout over the longitudinal gaps 128 is under tension and otherwise susceptible to cracks and associated water and salt infiltration, which would otherwise promote corrosion and generally reduce the expected lifespan of the structure. The finished structure, i.e. with the grout 132 applied, is shown in FIG. 12 and in section in FIG. 13. Herein it will be also seen that the centerline of the hook bars 114 is 50 mm above the bottom surface of the panel 100, as indicated by dimension D1. The overall height of the Nelson studs 122 is 75 mm and indicated by dimension E1. The offset F1, between the underside of the head of the Nelson studs 122 and the centerline of the hook bars, is 13 mm. The amount by which panels 100 overlap the beam 118 is 10 mm, as indicated by dimension C1.

### SUMMARY OF THE DISCLOSURE

An improved cementitious panel forms one aspect of the invention. The panel is of the type which, in use, is supported, with its upper surface in biaxial compression, by steel beams and forms part of a deck or roof in a modular structure. The improvement comprises a single layer of reinforcement in said panel.

According to another aspect of the invention, this panel can have concrete cover greater than 45 mm and a thickness between about 81 mm and about 126 mm.

According to other aspects of the invention, with respect to either of the panels above, the reinforcement can be a reinforcing lattice.

According to another aspect of the invention, the reinforcing lattice can be constructed from one or more of: glass-fibre reinforced polymer; stainless steel; hot-rolled deformed reinforcing rod; cold-rolled deformed reinforcing rod; and high-tensile cold-drawn wire.

According to another aspect of the invention, the lattice can comprise:
about 8 mm diameter high tensile cold-drawn wire extending transversely of the panel; and about 6 mm diameter high tensile cold-drawn wire extending longitudinally of the panel and rigidly interconnecting the about 8 mm wire; or
about 10 mm diameter deformed reinforcing rods extending longitudinally of the panel; and about 10 mm diameter deformed reinforcing rods extending transversely of the panel and rigidly interconnected to the longitudinally-extending rods by wire.

Forming another aspect of the invention is another improved cementitious panel. This panel is of the type which, in use, is supported, with its upper surface in biaxial compression, by steel beams and forms part of a deck or roof in a modular structure. In this panel, the improvement comprises concrete cover greater than 45 mm and a thickness between about 81 mm and about 126 mm.

According to other aspects of the invention, either of the panels above can:
have concrete cover between about 50 mm and about 59 mm and a thickness between about 101 mm and about 105 mm; and/or
have about 55 mm concrete cover and a thickness of about 105 mm; and/or
in use, span between about 2.5 metres and about 3.0 metres between beams; and/or
in use, span about 2.8 metres or about 2.5 metres between beams; and/or
in use, span up to about 10 metres along the beams supporting it

Forming another aspect of the invention is an improved modular structure.

The structure is of the type including panels which: each have a cementitious part; in use, are supported, each with its upper surface in biaxial compression, by steel beams and form part of a roof or deck of said structure; and are mechanically coupled to the beams by hook bars which extend from the panels to engage Nelson studs protruding from the beams.

The improvement comprises: a differential elevation, between the underside of the head of each Nelson stud and the centerline of the hook bar which engages said each Nelson stud, greater than 13 mm.

Forming another aspect of the invention is another improved modular structure. The modular structure is again of the type including panels which: each have a cementitious part; in use, are supported, each with its upper surface in biaxial compression, by steel beams and form part of a roof or deck of said structure; and are mechanically coupled to the beams by hook bars which extend from the panels to engage Nelson studs protruding from the beams.

In this improved structure, the improvement comprises: the use of the inventive panels; and a differential elevation, between the underside of the head of each Nelson stud and the centerline of the hook bar which engages said each Nelson stud, between about 18 mm to about 53 mm.

According to other aspects of the invention, with respect to either structure:
the differential elevation between the underside of the head of each Nelson stud and the centerline of the hook bar which engages said each Nelson stud can be about 29 mm to about 33 mm; and/or
the differential elevation between the underside of the head of each Nelson stud and the centerline of the hook bar which engages said each Nelson stud can be about 29 mm; and/or
the Nelson studs can have a height of about 80 mm to about 100 mm and the hook bars can have a diameter of about 10 mm; and/or
the Nelson studs can have a height of about 80 mm.

Forming yet another aspect of the invention is a facility comprising a mixer, a molding area and a rail-mounted concrete dispenser/finisher.

The mixer is for producing a supply of fluid concrete.

The molding area is for receiving a mold in use.

The concrete dispenser/finisher is in the form of a gantry adapted to, in use, receive said supply of fluid concrete from the mixer and deliver said supply of fluid concrete to the mold. The gantry includes dual vibrating screeds which move between raised and lowered positions. In use: (i) the gantry fills the mold with said supply of fluid concrete and finishes the concrete in a first pass over the mold with the screeds in the lowered positions; and (ii) the gantry returns towards the mixer in a second pass over the mold with the screeds in the raised positions.

According to another aspect of the invention, the facility can further comprise: a staging area, in which the mold is placed before filling; and a thumper cart, which transports the mold by rail from the staging area to the molding area for filling and, after the gantry has made its first pass, vibrates the mold to remove voids from the fluid concrete contained therewithin.

According to yet another aspect of the invention, as part of the vibration of the mold, the thumper cart can repeatedly drop the mold onto the floor.

Advantages of the invention will become apparent to persons of ordinary skill in the art upon review of the appended claims and upon review of the following detailed description of an exemplary embodiment of the invention and the accompanying drawings, the latter being described briefly hereinafter.

### BRIEF DESCRIPTION OF THE DRAWINGS

FIG. 1 is a perspective view of a panel according to the prior art;

FIG. 2 is an enlarged partial plan view of encircled area 2 of FIG. 1;

FIG. 3 is a side view of the structure of FIG. 2;

FIG. 4 is a schematic view of a support structure according to the prior art;

FIG. 5 is a view of the structure of FIG. 4, with jacks installed;

FIG. 6 is a view of the structure of FIG. 5, with panels installed;

FIG. 7 is a partial sectional view along 7-7 of FIG. 6;

FIG. 8 is a partial top plan view of the structure of FIG. 6, with a closed hook installed;

FIG. 9 is a view similar to FIG. 6 with the jacks removed and grout installed;

FIG. 10 is a view along 10-10 of FIG. 9;

FIG. 11 is a view along 11-11 of FIG. 9;

FIG. 12 is a view similar to FIG. 9 with top-coat applied;

FIG. 13 is a view similar to FIG. 10 with top-coat applied;

FIG. 14 is a top plan view of a mold according to an exemplary embodiment of the invention;

FIG. 15 is a top plan view of the interior of the mold in use;

FIG. 16 is a schematic view of the molding part of a panel building facility according to an exemplary embodiment of the invention;

FIG. 17 is a detailed perspective view of the structure indicated in encircled area 17 of FIG. 16;

FIG. 18 is a detailed perspective view of the component indicated in encircled area 18 of FIG. 16;

FIG. 19 is a partial, enlarged view of the structure of FIG. 18, from another vantage point;

FIG. 20 is a detailed perspective view of the component indicated in encircled area 20 of FIG. 16;

FIG. 21 is an enlarged view of the structure of FIG. 20, from another vantage point;

FIG. 22 is a view of the components of encircled areas 17, 18, 20 and 22 of FIG. 16;

FIG. 23 is a view of a panel constructed according to the exemplary embodiment, the view being similar to FIG. 3;

FIG. 24 is a view identical to FIG. 13;

FIG. 25 is a view similar to FIG. 13, but of a structure constructed with the panel of FIG. 23; and

FIG. 26 is a view similar to FIG. 25, of a structure according to another exemplary embodiment of the invention.

### DETAILED DESCRIPTION

An exemplary process for manufacturing pre-cast panels is hereinafter described in detail, but for clarity, the concrete and mold used in the exemplary process are initially described.

### Concrete

The concrete employed in the exemplary embodiment has the following physical properties:
compressive strength>45 MPa in 28 days
   CSA 23.2-9C/ASTMA C1074
water absorption<4% [CSA A23.2-11C]
salt scaling freeze/thaw<800 mg/m²
   MTO LS-412/ASTMA C672
linear shrinkage<0.04% [MTO LS-435]
chloride permeability<1000 Coulombs [ASTMA C1202]
chloride diffusion coefficient<1.8×10⁻¹² m²/s
lifecycle>40 years according to LIFE365 model

Concrete having these performance characteristics can be readily produced by persons of ordinary skill in the art, and thus, is not described herein in detail.

### Mold

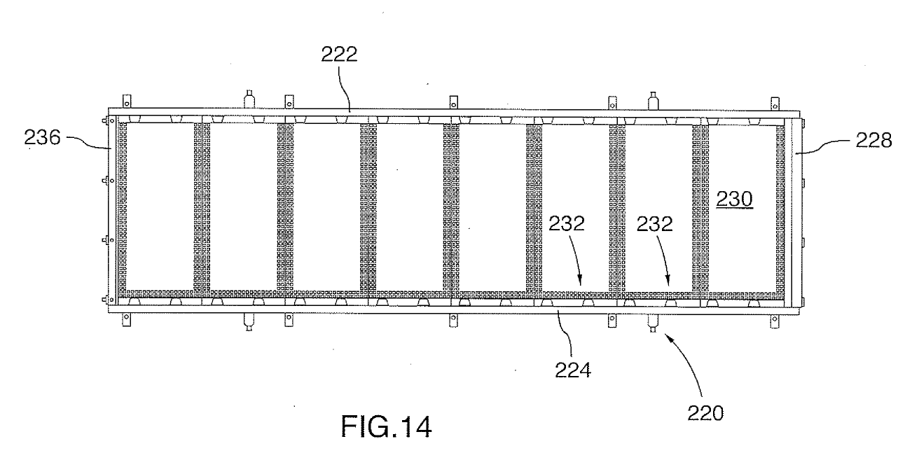

With general reference to FIG. 14, the exemplary mold 220 is in the form of a table and will be seen to be comprised of side bars 222,224 and end bars 226,228, collectively referred to as the perimeter bars, and a surface die 230. The surface die 230 has a textured upper surface and forms the surface of the mold table. Side bars 222,224 and end 226,228 bars are releasably attached to the mold table by fasteners (not shown). The side bars 222,224 have trapezoidal protusions 232 formed thereon, to define recesses in the finished panels, these protrusions 232 having slots (not shown) defined therethrough.

### The Mold Table in Use

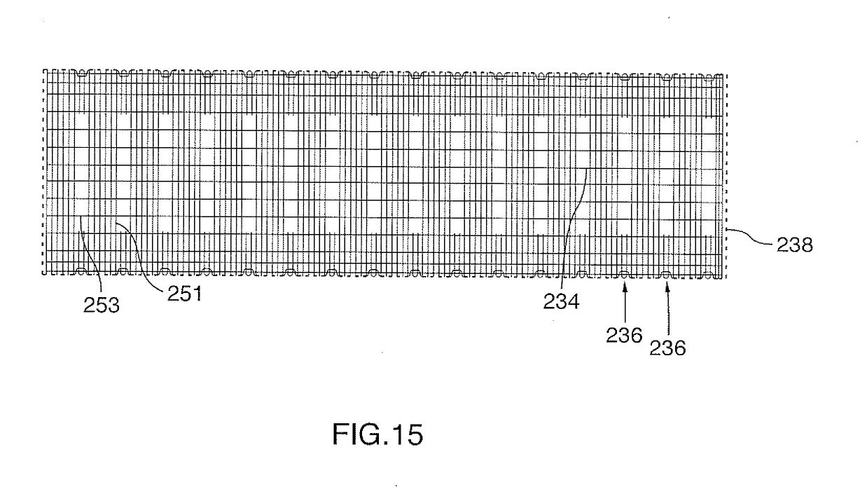

The mold 220 is used with internal elements which include cementitious bar chairs, a rebar mat 234 and hook bars in the form of u-shaped rebar elements 236. FIG. 15 is a plan view showing the position of the rebar mat 234 and the hook bars 236 with relation to the inside perimeter of the mold 220, the perimeter being indicated in dotted outline 238. The rebar mat 234 is made out of 8 mm diameter high tensile cold drawn steel wire 251 extending traversely of the panel and 6 mm diameter steel cold drawn wire 253 extending longitudinally, welded together in a lattice that is slightly smaller in external dimensions than the interior dimensions of the mold and, in use, is supported on the bar chairs (not shown) which are placed throughout the mold 20 to elevate the reinforcement 234 a predetermined distance from the surface die 230.

The hook bars 236 are 10 mm diameter rebar elements which extend through the slots in the protrusions 232. With the internal elements positioned as indicated above, the mold 220 is ready to be filled with concrete.

With regard to the bar chairs, not shown, same are cementitious, since, in the molding process, they rest on the surface die 230 which, as discussed further below, forms the upper surface of the finished panel; this means that the bases of the bar chairs define part of the upper surface.

For this reason, the bar chairs are advantageously made corrosion resistant and otherwise compatible with the concrete, so as to avoid the potential for crack propagation, water or salt infiltration, etc.

### Process

The exemplary process for constructing panels will now be described.

The process involves the use of a manufacturing system which includes a molding system and a de-molding system.

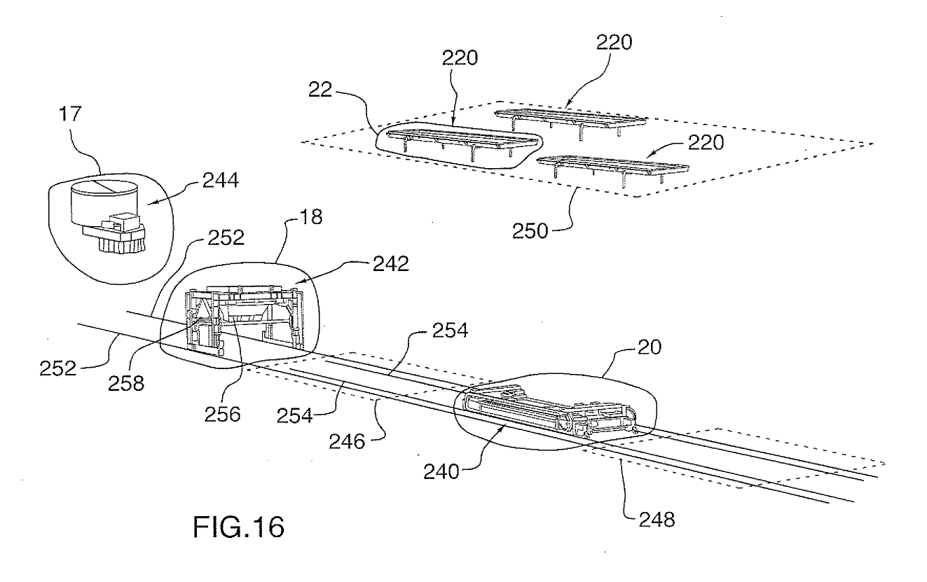

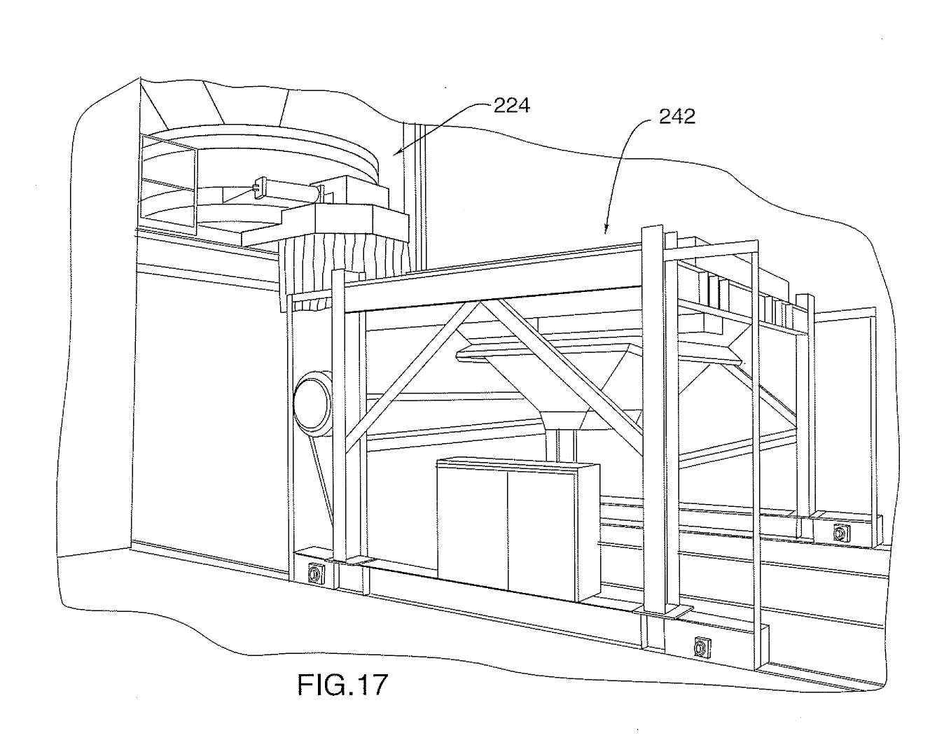

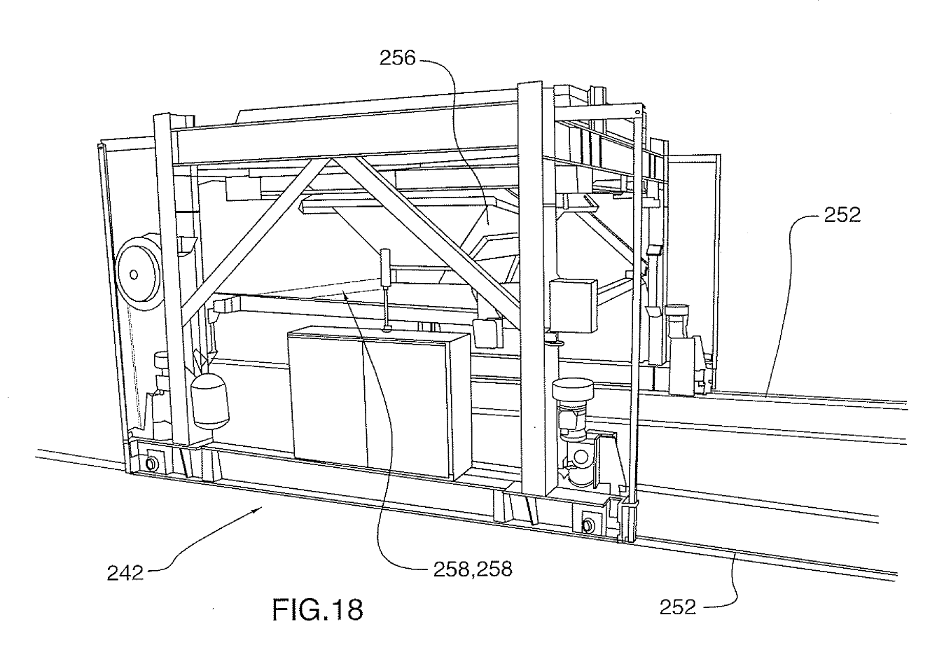

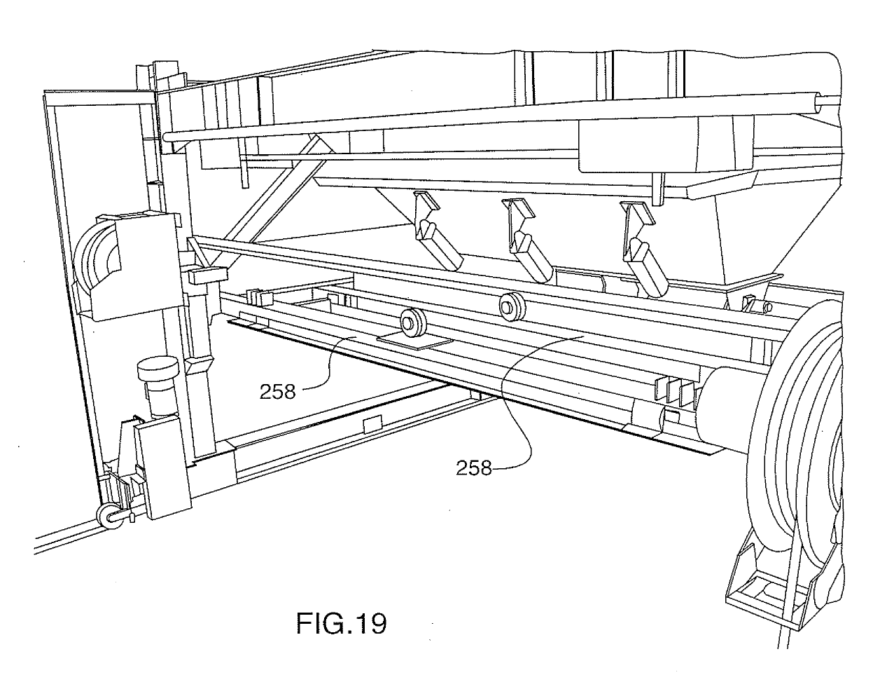

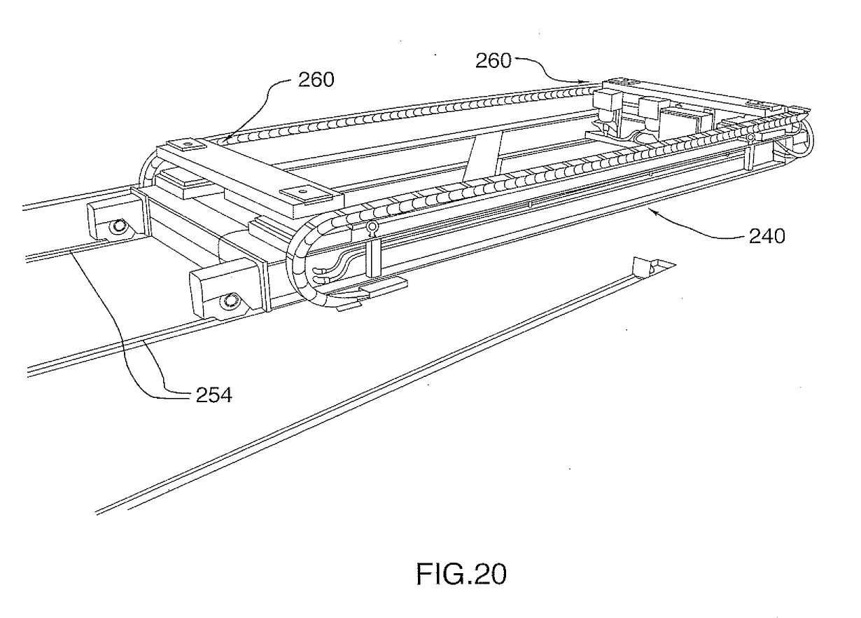

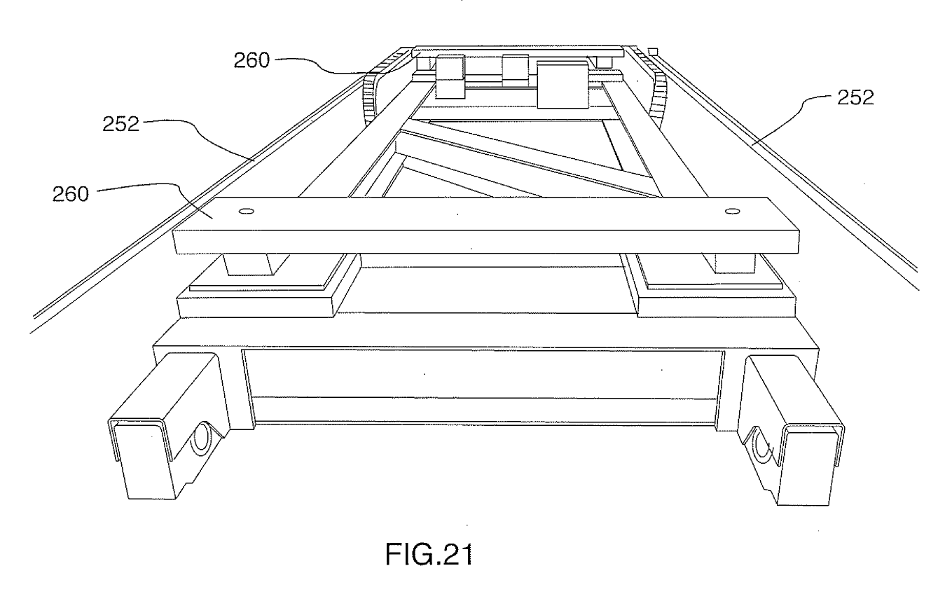

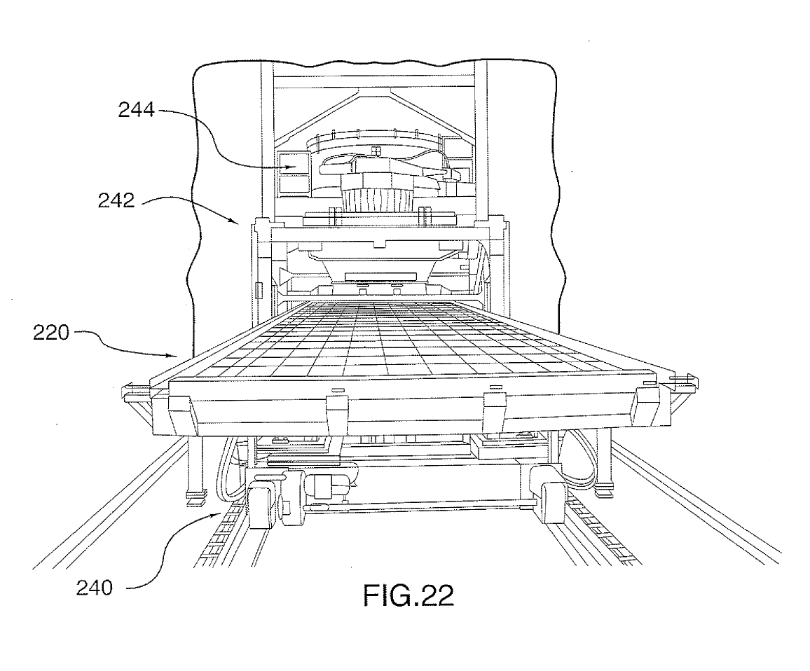

The exemplary molding system includes molds 220, a thumper cart 240, a gantry 242 and a mixer 244, all as indicated in FIGS. 16-22. The molding system is disposed in a facility having an indoor molding area 246, an indoor staging area 248 and an indoor solidifying area 250, all as indicated schematically in FIG. 16.

In a starting configuration:
the gantry 242 is disposed in position under the mixer 244 to receive a batch of fluid concrete;
a mold 220 is disposed at the molding position 246, ready to receive fluid concrete; and
the thumper table 240 is disposed at the molding position 246, beneath the mold 220

Once the gantry 242 is filled with fluid concrete, it travels along outer rails 252 towards the molding area 254, until its chute 256 is above the mold 220. Then, the chute 256 is opened and the gantry 242 moves over the mold 220, filling it with fluid concrete.

Trailing the chute 256 are twin vibrating screeds 258 which screed the fluid concrete, to produce, in a single pass, a finished concrete surface.

After the first pass has been completed, the screeds elevate 258, and the gantry 242 retracts to its original position under the mixer 244.

With the gantry 242 retracted, the thumper cart 240 vibrates the mold 220. The thumper table 240 has hydraulic lifters 260, that elevate the mold 220 and then quickly retract, to drop the mold 220 against steel plates embedded in the floor.

The impact of the mold 220 striking the floor produces strong vibrations that remove most voids from the concrete.

Importantly, the concrete facing the surface die 230, which ultimately forms the upper surface of the deck panel, obtains a relatively smooth, void-free surface through this process.

Once vibration has completed, and the desired substantially void-free casting has been created:
the mold 220 is moved from the molding position by an overhead crane and taken to the hardening area 250; and
contemporaneously, the thumper cart 240 moves to the staging area 248, to pick up an empty mold, for subsequent filling, and transport the empty mold to the molding area 246.

Multiple advantages flow from the present molding process and facility as compared to the known prior art.

As one advantage, the use of twin screeds provides a satisfactory surface finish without hand finishing, thereby reducing labor costs.

As another advantage, the use of dual rails decouples mold removal from mold placement, to permit increased production rates. The use of a rail system, particularly, allows for relatively precise, quick movement of the mold table to the molding position from the staging area.

### Concrete Slab

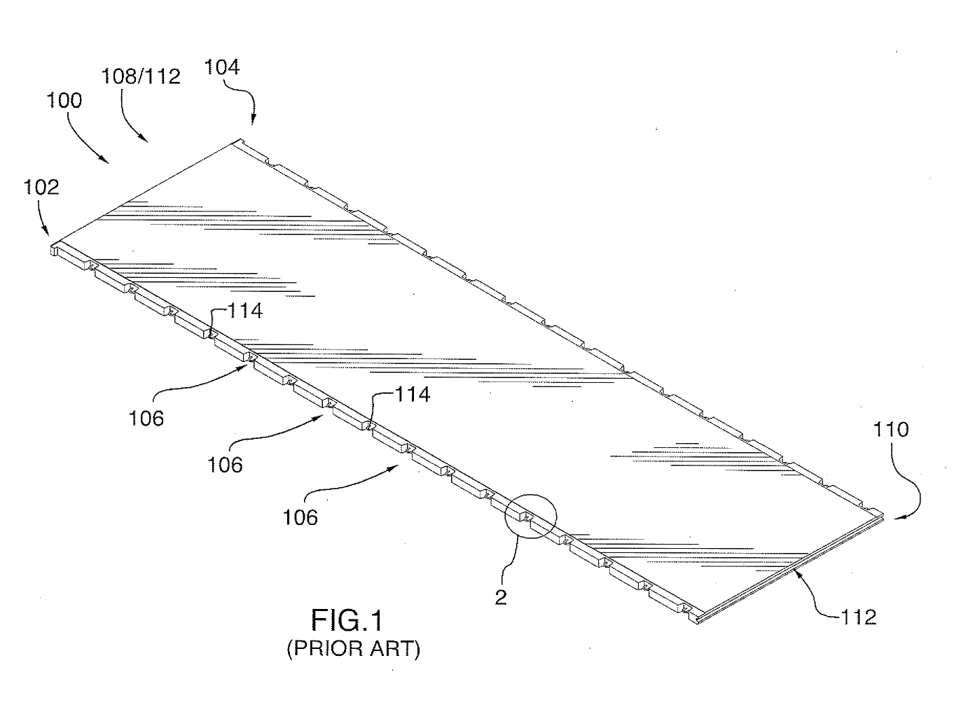

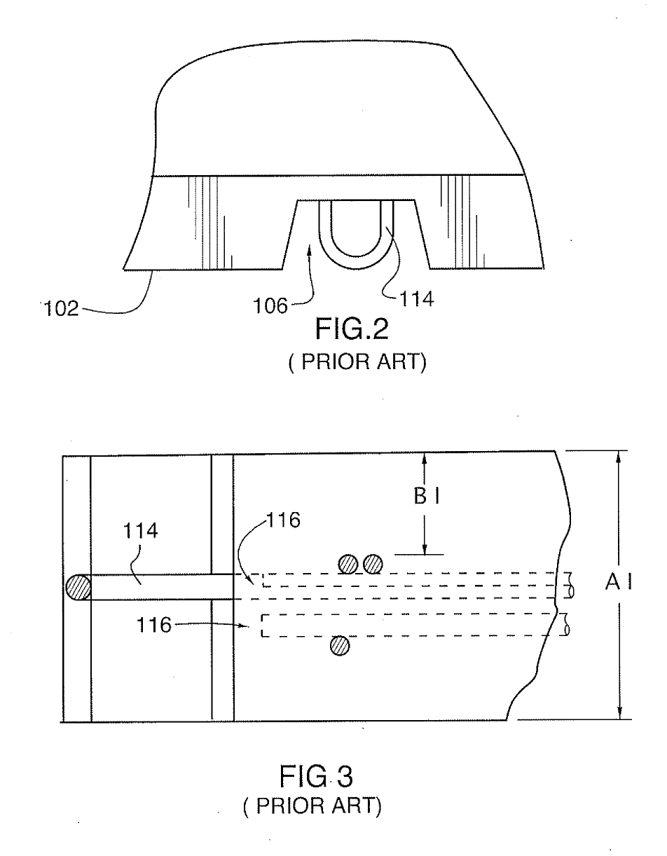

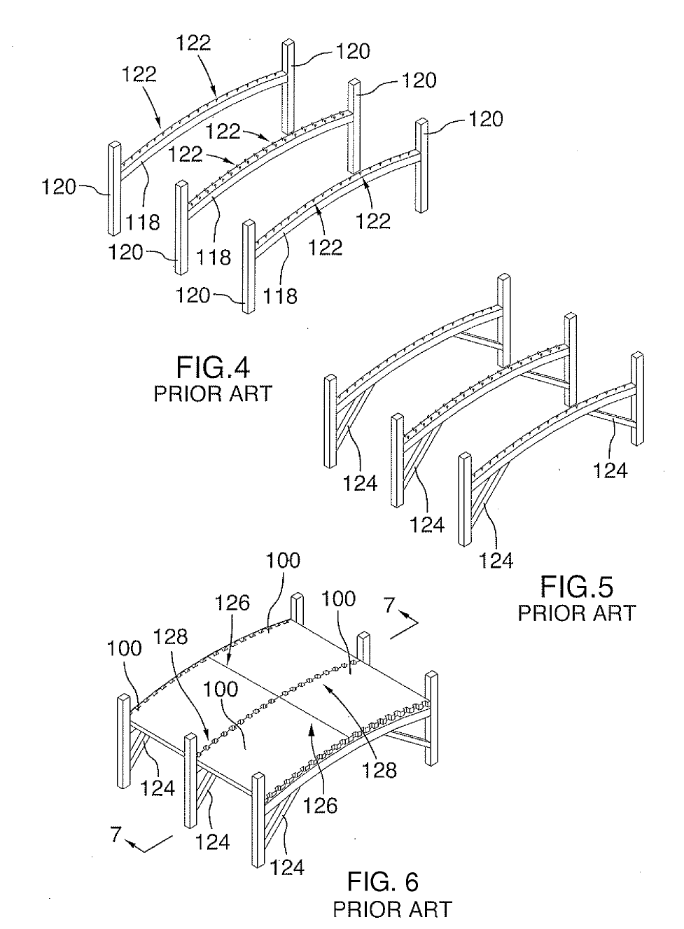

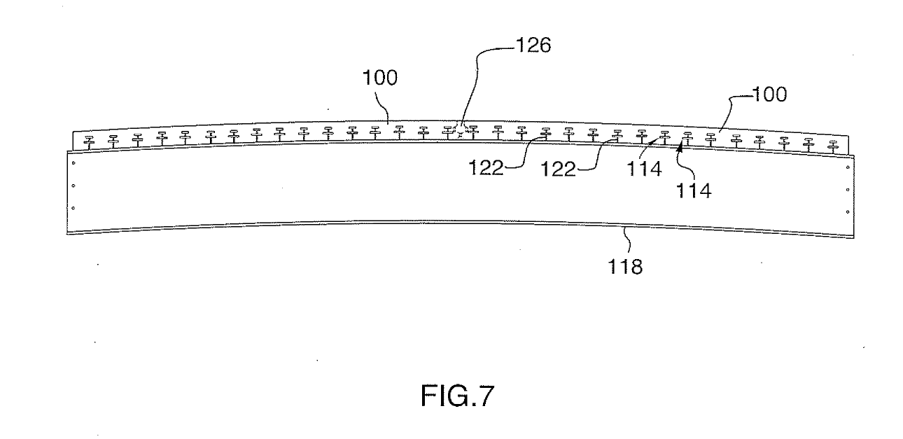

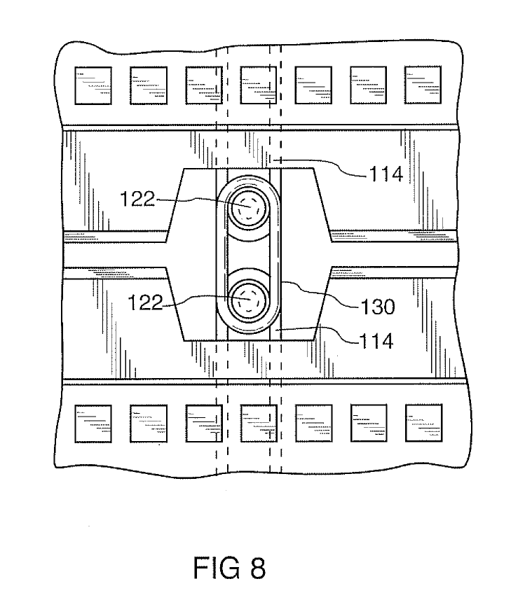

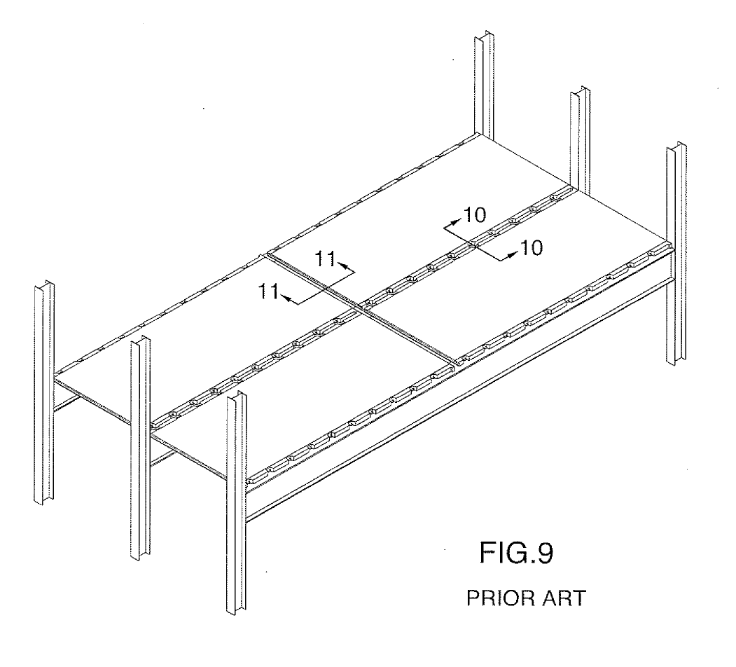

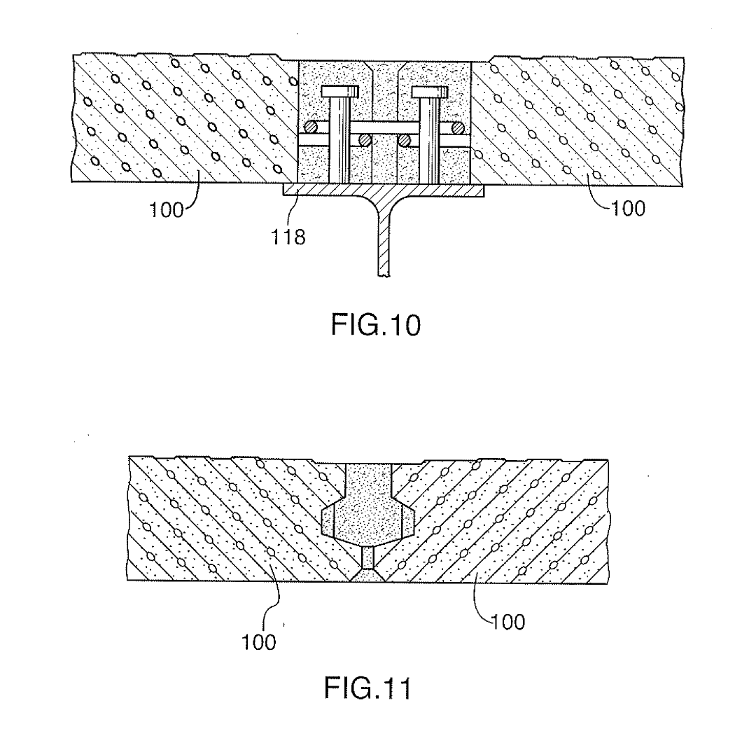

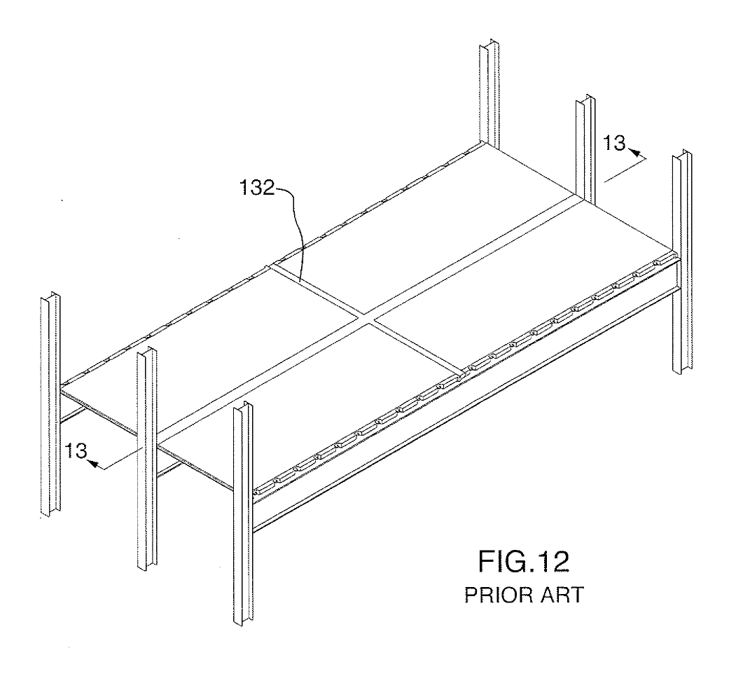

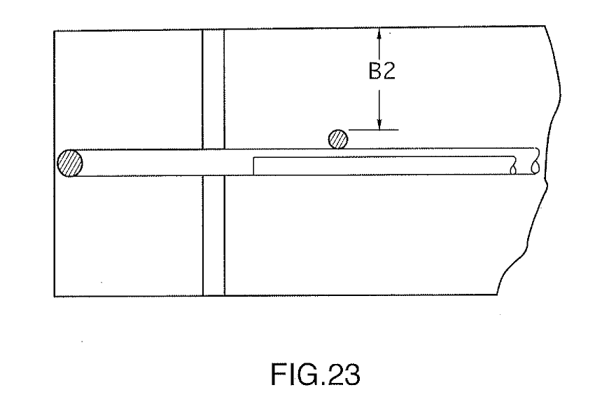

After the concrete has hardened sufficiently, the concrete and reinforcement merge to create a panel which can be removed from the mold in a conventional manner. This panel is generally similar, exteriorly, to the prior art panel of FIGS. 1-3. However, with reference to FIG. 23, which shows an exemplary panel, the panel will be seen to have increased concrete cover as compared to the prior art, specifically 55 mm, as indicated by dimension B2. It will be recalled that dimension B1 in the prior art was 42-45 mm. An advantage of the increased concrete cover is increased impermeability of the concrete slab resulting in a structure with an extended operational life and, in some jurisdictions, the ability to omit the use of a protective topping on the concrete surface, which significantly reduces lifetime maintenance costs.

In the jurisdiction of Ontario, Canada, for example, a parking garage structure of the general type in question, with concrete coverage of only 42-45 mm, would likely be required to have a waterproofing coating applied every 2-5 years, adding greatly to lifetime structure costs over 55 mm coverage structures, which would not be subject to this obligation.

### Structure

Panels according to the present invention can, surprisingly, notwithstanding the absence of the conventional second layer of reinforcement, be assembled into a useful modular structure in the conventional manner previously described.

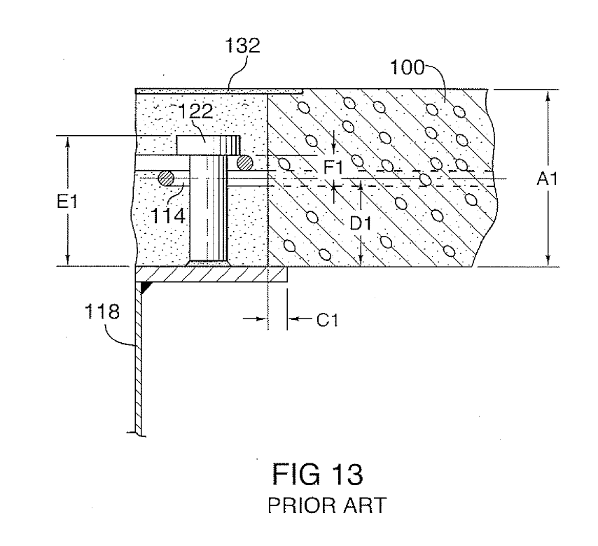

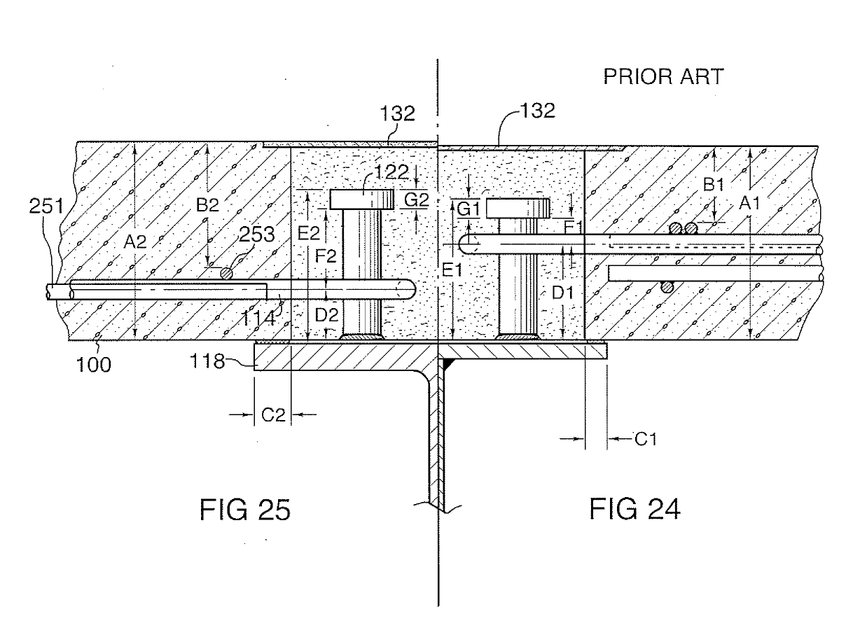

FIG. 25 is a view similar to FIG. 13, but showing the structure of the present invention, and for comparison, is illustrated next to FIG. 24, which is a view identical to FIG. 13.

For clarity, the various dimensions of the structures in FIG. 24 and FIG. 25 are set out below, in mm:

| | | | | | | | |
|---|---|---|---|---|---|---|---|
| FIG. 24 | A1 = 103 | B1 = 42-45 | C1 = 10 | D1 = 50 | E1 = 75 | F1 = 13 | G1 = 10 |
| FIG. 25 | A2 = 105 | B2 = 55 | C2 = 19 | D2 = 39 | E2 = 80 | F2 = 29 | G2 = 10 |

From this, it will be understood that the panel of the present invention has beam overlap of 19 mm, as indicated by dimension C2, a significant increase over the 10 mm overlap C1 of the prior art. The concrete slab of the present invention also has increased Nelson stud rise F2 of 29 mm as compared to prior art F1 rise of 13 mm.

Without intending to be bound by theory, it is believed that these dimensional differences enable structures according to the present invention to be built with less reinforcement than structures of the prior art.

The stronger structure may be the result of less Nelson stud flexion, due to the lower positioning D2 of the u-shaped rebar element and increased offset F2; and/or increased lateral reaction forces, due to increased stud penetration E2 in the grouted gaps.

The increased overlap C2 provides additional tolerance in construction, and has some advantage in terms of reduced grout leakage, associated with the lengthened leak path.

Whereas but various exemplary embodiments have been herein described, it will be evident that numerous variations are possible therein.

Importantly, whereas a panel is shown in FIG. 24 which has concrete cover of 55 mm, cover could be increased to 59 mm in a panel of the same thickness by lowering the reinforcement mat by 4 mm. This would still leave 30 mm bottom concrete ‘coverage’, a requirement in some jurisdictions for steel reinforced structures.

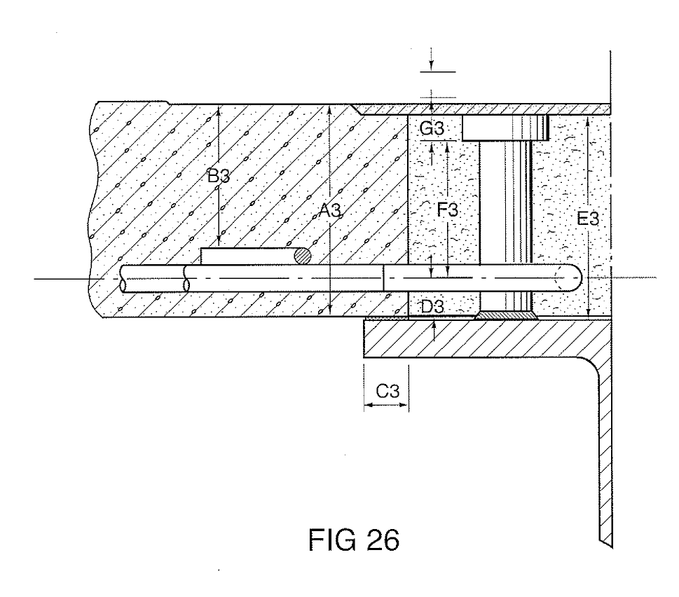

Of course, if the reinforcement was lowered by 4 mm, the thickness of the panel could be reduced by 4 mm, i.e. to 101 mm, while still leaving 55 mm top cover. Bottom coverage could be increased further by adding additional concrete; the panel thickness could readily be increased by 21 mm, to a total of 126 mm, which would result in bottom coverage of 55 mm and top coverage of 55 mm. Top coverage could also be increased. Additional bottom coverage could be advantageous in some applications for soundproofing purposes. Additional top cover could increase lifespan and be advantageous for soundproofing purposes. Top cover can be reduced from 55 mm, but reductions below 50 mm would be expected to have substantial disadvantage in terms of lifespan. Reductions in bottom coverage to 10 mm, with top coverage at 55 mm, would result in a 81 mm thick panel and differential elevation F3 of 53 mm, as shown in FIG. 26; in some applications, this would require suitable accommodation for fire-resistance, i.e. a sprinkler system, or accommodations for corrosion, for example, stainless reinforcement. For clarity, the dimensions of the structure shown in FIG. 26 are, in mm: A3=81 B3=55 C3=19 D3=15 E3=80 F3=53 G3=10

These variations on panel thickness and reinforcement level and type would have commensurate impacts on the differential elevation between the underside of the Nelson stud and the centerline of the hook bar; the illustrated differential of 29 mm in FIG. 25 could readily be increased to 33 mm by a suitable lowering of the reinforcement by 4 mm. Similarly, in 105-126 mm panels, the reinforcement could be raised another 11 mm, permitting a differential elevation of 18 mm.

Differential elevation can also vary with the height of the Nelson stud, which can range between 80 mm and 100 mm in the context of a parking garage structure having panels of the general type described herein. Of course, the overall thickness of the panel should be sufficient to permit the Nelson studs to be grouted over and coated.

Further, whereas the illustrated panel was indicated to be 2.5 metres in width, another typical size is 2.8 metres, and it is known that panels of up to 3.0 metres in width could be used in association with the above-described panel structure [ie without changing panel thickness or reinforcement].

Similarly, whereas the illustrated panel is indicated to be 9.0 metres in length, this is a convenient length, only. Panels, of, for example, 10.0 metres in length could be manufactured. The limiting factor in terms of length is road transportation regulations and crane capacity. Shorter panels, and irregular shaped panels, could and would also be used, for ramps and other structures.

Yet other variations are also possible.

Accordingly, the invention should be understood as limited only by the accompanying claims, purposively construed.

The invention in which an exclusive property or privilege is claimed is defined as follows:

1. An improved cementitious panel of the type which, in use, is supported, with its upper surface in biaxial compression, by steel beams and forms part of a deck or roof in a modular structure, wherein the improvement comprises a single layer of reinforcement in said panel.

2. The panel according to claim 1, wherein the panel has concrete cover greater than 45 mm and a thickness between about 81 mm and about 126 mm.

3. The panel according to claim 1, wherein the reinforcement is a reinforcing lattice.

4. The panel according to claim 3, wherein the reinforcing lattice is constructed from one or more of: glass-fiber reinforced polymer; stainless steel; hot-rolled deformed reinforcing rod; cold-rolled deformed reinforcing rod; and high-tensile cold-drawn wire.

5. The panel according to claim 4, wherein the reinforcing lattice comprises one of:
(i) about 8 mm diameter high-tensile, cold-drawn wire extending transversely of the panel, and about 6 mm diameter high-tensile, cold-drawn wire extending longitudinally of the panel and rigidly interconnecting the about 8 mm diameter wire; or
(ii) about 10 mm diameter deformed reinforcing rods extending longitudinally of the panel, and about 10 mm diameter deformed reinforcing rods extending transversely of the panel and rigidly interconnected to the longitudinally-extending rods by wire.

6. An improved cementitious panel of the type which, in use, is supported, with its upper surface in biaxial compression, by steel beams and forms part of a deck or roof in a modular structure, wherein the improvement comprises concrete cover greater than 45 mm and a thickness between about 81 mm and about 126 mm.

7. The panel according to claim 6, wherein the panel has concrete cover between about 50 mm and about 59 mm and a thickness between about 101 mm and about 105 mm.

8. The panel according to claim 7, wherein the panel has about 55 mm concrete cover and a thickness of about 105 mm.

9. The panel according to claim 8, wherein the panel, in use, spans between about 2.5 meters and about 3.0 meters between steel beams.

10. The panel according to claim 8, wherein the panel, in use, spans about 2.8 meters or about 2.5 meters between beams.

11. The panel according to claim 10, wherein the panel, in use, spans up to about 10 meters along the steel beams supporting it.

12. An improved modular structure of the type including panels which:
(i) each have a cementitious part;
(ii) in use, are supported, each with its upper surface in biaxial compression, by beams and form part of a roof or deck of said structure; and
(iii) are mechanically coupled to the beams by hook bars which extend from the panels to engage Nelson studs protruding from the beams, wherein the improvement comprises:
a differential elevation, between the underside of the head of each Nelson stud and the centerline of the hook bar which engages said each Nelson stud, of greater than 13 mm.

13. The modular structure according to claim 12, wherein the differential elevation between the underside of the head of each Nelson stud and the centerline of the hook bar which engages said each Nelson stud is between about 18 mm to about 53 mm.

14. The modular structure according to claim 12, wherein the differential elevation between the underside of the head of each Nelson stud and the centerline of the hook bar which engages said each Nelson stud is about 29 mm to about 33 mm.

15. The modular structure according to claim 12, wherein the differential elevation between the underside of the head of each Nelson stud and the centerline of the hook bar which engages said each Nelson stud is about 29 mm.

16. The modular structure according to claim 15, wherein
the Nelson studs have a height of about 80 mm to about 100 mm; and
the hook bars have a diameter of about 10 mm.

17. The modular structure according to claim 16, wherein the Nelson studs have a height of about 80 mm.

18. A facility comprising:
a mixer for producing a supply of fluid concrete;
a molding area for receiving a mold in use; and
a rail-mounted concrete dispenser/finisher in the form of a gantry adapted to, in use, receive said supply of fluid concrete from the mixer and deliver said supply of fluid concrete to the mold,
wherein the gantry includes dual vibrating screeds which move between raised and lowered positions, and, in use: (i) the gantry fills the mold with said supply of fluid concrete and finishes the concrete in a first pass over the mold with the screeds in the lowered positions; and (ii) the gantry returns towards the mixer in a second pass over the mold with the screeds in the raised positions.

19. The facility according to claim 18, further comprising:
a staging area, in which the mold is placed before filling; and
a thumper cart, which transports the mold by rail from the staging area to the molding area for filling and, after the gantry has made its first pass, vibrates the mold to remove voids from the fluid concrete contained therewithin.

20. The facility according to claim 19, wherein, as part of the vibration of the mold, the thumper cart repeatedly drops the mold onto the floor.
